(19) United States
(12) Patent Application Publication
(10) Pub. No.: US 2006/0103503 A1
(43) Pub. Date: May 18, 2006

(54) Networked movable barrier operator system

(76) Inventor: Yan Rodriguez, Suwanee, GA (US)

Correspondence Address: Phillip L. Kenner;RENNER, KENNER, GREIVE, BOBAK TAYLOR & WEBER, First National Tower, Fourth Floor, Akron, OH, 44308-1456, US

(21) Appl. No.: 10/988,104

(22) Filed: Nov. 12, 2004

(51) Int. Cl. H04Q 1/00; G05B 19/00

(52) U.S. Cl. 340/5.71; 340/5.64; 340/5.26

(57) ABSTRACT

A networked movable barrier operator for moving a barrier between limit positions including a motor attachable to the barrier, at least one non-network device, and at least one network device. A controller is connected to the motor and communicates operational signals between the non-network device and the network device to the motor, and communicates operational signals between the motor and the non-network device and the network device.

### TECHNICAL FIELD

The present invention is generally related to a home network interface incorporated into a movable barrier operator. In particular, the present invention is related to a movable barrier operator that communicates with both non-network transmitters and network transmitters, wherein the network interface is capable of controlling, acquiring data from, and posting data to other network devices anywhere in the world, while also controlling operation of a movable barrier.

### BACKGROUND ART

A movable barrier operator contains control electronics and an electric motor which is linked to a movable barrier such as garage doors, curtains, retractable awnings, gates and the like for the purpose of opening and closing the barrier. Known operators are capable of receiving “local” signals for receiving and processing requests or commands to move the barrier. Requests to move the barrier can be transmitted by either hard wired signals, or via wireless transmissions from different types of devices. These devices are in the form of wired and wireless wall stations transmitters, wireless transmitters, wired or wireless keyless entry transmitters, wireless vehicle mounted transmitters, and “hands-free” proximity transmitters. These known types of transmitters are collectively referred to herein as local transmitters.

Portable and/or handheld remote local transmitters consist of radio-frequency (RF) transmitters that when actuated send RF signals with embedded codes to the barrier operator. The codes can either be fixed or rolling code sequences of data that uniquely identify the transmitter to the barrier operator. Rolling code sequences allow for more secure access to control the barrier operator, since they thwart so called “sniffing” or “code grabbing” of fixed access codes.

Known prior art operators have limited capability of communicating their internal operating status to the outside world. Prior art operators typically limit their internal status reporting to local signaling via a series of light flashes, LED flashes, or audible beeps. And users must be in close proximity to the operator to observe feedback. Furthermore, the feedback capacity of operators is very limited and in most cases it is only accessible at the time of the operator encountering a problem. In-depth diagnosis of this type of operator is inadequate. Other known prior art operators can monitor and internally store the working parameters and characteristics of the barrier creating a working “profile” of the barrier. But, current or historical profile information is not easily accessible by the user or installer.

In addition to limited outbound communications with the outside world, prior art operators also have limited receive functions. Known prior art operators contain a wired interface designed to receive a limited number of control commands. These wired interfaces are designed to operate in close proximity to the operator. Prior art operators also include wireless receivers capable of receiving short range signals from wireless transmitters. Although the wireless receiver system allows for more control command options such as in the case of multi-function wireless wall stations, the commands are still limited in scope and are only “local” (short range).

Although the aforementioned operators are effective in their stated purpose, they do not address the need to incorporate a movable barrier operator into a network system. In other words, there is a need for a movable barrier operator that serves as a conduit between a network and components associated with the operator. And, given the prior art limitations, a new operator control system capable of transmitting internal operating status to the outside world is needed. Profile information, if accessible, can be very useful to service personnel to diagnose and correct complete system problems. Furthermore, transmitter information which is unique to each individual unit and stored inside the operator memory system can be used to identify unique users, the number of users in the system and when the user activated the operator.

Alarm signals such as for broken springs, entrapments, time for service, etc. are useful for consumers who wish to have a higher level of security and control from their operator and for service personnel diagnosing problems. Accessing this information remotely is also useful for consumers who have a need to manage and monitor the operator system from remote locations such as a second home, workplace or even via a cell phone. Remote access of operator status is also useful for service personnel who wish to diagnose operator problems before making a service call.

### SUMMARY OF THE INVENTION

Therefore, there is a need in the art for a networked movable barrier operator system.

Another aspect of the present invention, which shall become apparent as the detailed description proceeds, is achieved by a movable barrier operator for moving a barrier between limit positions, comprising a motor attachable to the barrier; at least one non-network device; at least one network device; and a controller connected to said motor, said controller communicating operational signals between said at least one non-network device and said at least one network device to the motor, and communicating operational signals between the motor and at least one non-network device and at least one network device.

A further aspect of the invention is to provide a system for moving a barrier between limit positions, comprising a motor linked to the barrier; a non-network receiver; a network transceiver; and an operator controller programmed to: maintain an operator memory device which stores approved codes therein; receive operational signals from non-network devices via the non-network receiver and from network devices via the network transceiver, the operational signals having a command code contained therein; and compare the command codes to the approved codes, and if a match is found, generate another the operational signal to one of the motor, the non-network devices, and the network devices.

These and other aspects of the present invention, as well as the advantages thereof over existing prior art forms, which will become apparent from the description to follow, are accomplished by the improvements hereinafter described and claimed.

### BRIEF DESCRIPTION OF THE DRAWINGS

For a complete understanding of the objects, techniques and structure of the invention, reference should be made to the following detailed description and accompanying drawings, wherein:

FIG. 1 is a schematic diagram of a home network employing a networked barrier operator system in accordance with the concepts of the present invention;

FIG. 2 is a schematic diagram of the networked barrier operator system in accordance with the concepts of the present invention.

FIG. 3 is an operational flow chart illustrating the steps implemented in processing signals by an operator controller and a network controller used in the operator system; and

FIG. 4 is an operational flow chart illustrating the steps implemented in authenticating signals received by the operator controller.

### BEST MODE FOR CARRYING OUT THE INVENTION

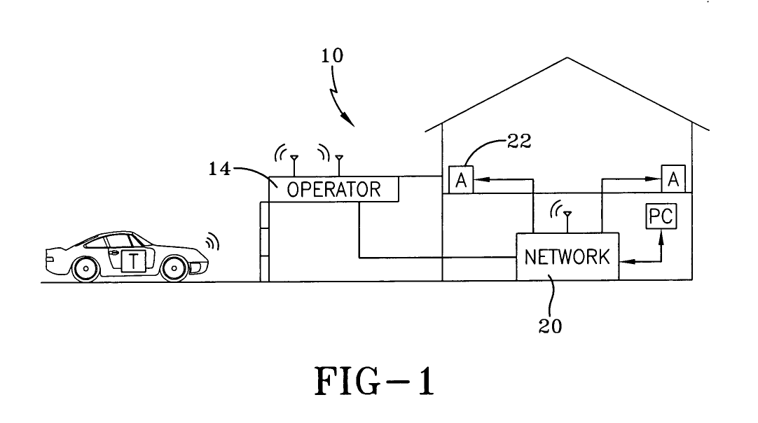

Referring now to the drawings and, in particular, to FIG. 1, it can be seen that a networked movable barrier operator system is designated generally by the numeral 10. Generally, the operator system 10 is utilized much like a movable barrier operator system but with additional features that allow for communications to be exchanged with a network and network transmitters in addition to local transmitters. As is common with most operator systems 10, the system 10 is installed in a building, such as a garage, house, factory, or warehouse; or the system 10 may be employed in a gated community wherein a single gate allows access to multiple users. Each operator system includes an operator controller 14 which is a microprocessor-based device that receives and generates wired or wireless signals; and includes the necessary hardware, software and memory for enabling the system. The operator controller 14 includes the ability to process “local” signals from transmitters and the like, and to also receive global or network signals from non-local or network devices that are part of a home, local area, wide area, cell phone or other computer-based network.

The operator controller 14 is used in conjunction with a barrier 16 which may be of most any type. The barrier 16 is typically a garage door, but it will be appreciated that the disclosed system may be also used with curtains, retractable awnings, gates and any other type of barrier that moves between known limit positions. Accordingly, a local or network device may generate a transmission signal that is received by the operator controller so as to allow for movement of the barrier in a desired direction. The operator system 10 may include a network 20 which may be associated with the structure that contains the movable barrier, although it will be appreciated that the network may be physically removed from the operator system. In any event, the network 20 is typically associated with appliances 22, peripheral devices, personal computers and the like that may or may not be associated with the facility. The network 20 may be connected either via wires or by wireless communication devices to the appliances such as air conditioners, furnaces, lights contained throughout the facility, entertainment systems, refrigerators, scales, plumbing fixtures and the like. And, the network may be linked to other networks contained within a community or within a facility. Control of the network 20 may be implemented by a personal computer—(designated as PC in the drawing),—a personal digital assistant, or any other processor-based device.

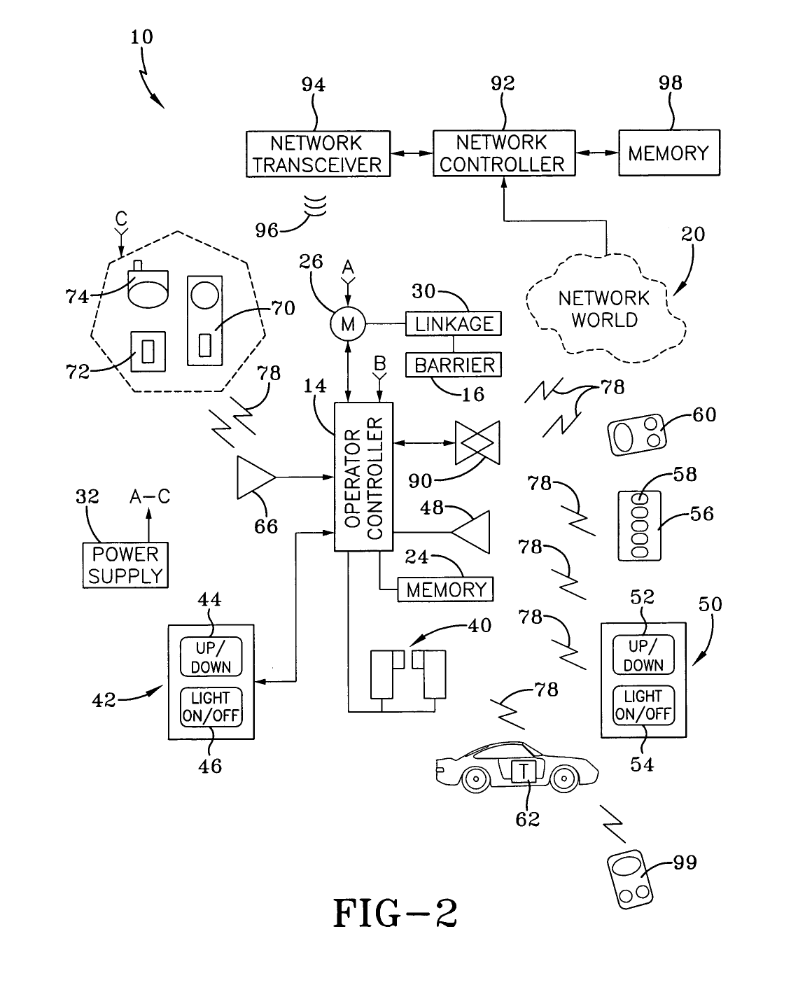

As best seen in FIG. 2, the system 10 includes the operator controller 14 which is connected to a non-volatile memory device 24 which stores identifying codes contained within operational signals exchanged between the controller and other devices. These codes specifically identify each transmitter so that the controller can determine whether it is an approved device or not. In other words, the controller compares each code received with those codes stored in the memory 24 to determine whether further action should be taken or not. Also connected to the controller 14 is a motor 26 which may be an AC or DC device that allows for sufficient generation of power to move the barrier 16 in a safe and efficient manner between limit positions. The motor 26 is connected to linkage 30 which is connected to the barrier 16. The linkage 30 functions to convert the mechanical power generated by the motor in such a way as to move the barrier 16 between limit positions. The linkage 30 is typically a counter-balance system that may either be header-mounted, ceiling-mounted, a trolley or any other configuration needed to implement movement of the barrier from one position to another. A power supply 32 is included in the system 10 and supplies power to the controller 14, the motor 26 and any other component contained within the system as needed. It will be appreciated that the power supply may be a residential or industrial power source that is stepped up or down, or conditioned as needed by the specific component. The power supply 32 may also include any back-up power supplies, such as batteries and the like to ensure continuous operation of the system 10.

A plurality of local or non-network transmitters, or devices may be connected to or associated with the operator controller 14. These non-network devices communicate with the controller either via a wire or wireless signal. These devices are learned or programmed for use with the controller 14 by actuation of a learn button associated with the operator controller and then actuation of a single or multiple buttons associated with each transmitter or device. Or, the foregoing learning steps may be reversed. In any event, one of the local devices may be a safety sensor 40 such as a photo-electric eye, an astragal sensor or other device which detects obstructions in the path of the barrier as it moves between positions. If an obstruction is detected by the sensor 40, this information is communicated to the controller 14 so that it may take the appropriate corrective action. Another local device may be a wired wall station 42 which is typically positioned near an interior access door associated with the area enclosed by the movable barrier. A typical wall station 42 includes an up-down switch 44 and a light on/off switch 46. It will be appreciated that other buttons may be associated with the wall station 42, such as for adjusting door height to allow ingress and egress of pets, to actuate various learning or operational modes of the controller and the like.

A wireless receiver 48 may be connected to the controller 14 for the purpose of receiving radio frequency (RF) signals. Of course, other wireless signals, such as acoustic or infrared could be used with an appropriately configured receiver. The wireless receiver usually receives one type of frequency signal but it will be appreciated that multiple frequency signals or different frequency signals may be received and then processed by the controller 14. The wireless receiver 48 receives signals from non-network devices such as a wireless wall station 50 which functions in much the same manner as the wired wall station 42. Indeed, the wall station transmitter 50 includes an up/down switch 52 and a light on/off switch 54. Accordingly, when any one of these switches associated with the wall station transmitter 50 is actuated, the transmitter 50 generates a wireless signal at a pre-designated frequency that is received by the receiver 48. Another type of local wireless device is a keyless entry transmitter 56 which allows for a user to enter a personal identification number (PIN) so as to allow access to the barrier within the barrier. The keyless entry transmitter 56 includes a plurality of buttons 58 that when actuated in a pre-designated sequence allows for opening and closing of the barrier via the operator controller 14.

A local remote transmitter 60 is another non-network device that may be associated with the operator controller 14. The remote transmitter, which may be referred to as portable or a handheld remote, is typically carried in an automobile or other vehicle. Actuation of any one of the buttons on the remote transmitter 60 generates a signal that is received by the receiver 48 and then processed by the operator controller 14 so as to move the barrier or perform other functions enabled by the controller. Yet another type of local transmitter is a vehicle-mounted transmitter designated generally by the numeral 62. The transmitter may be installed in a car, such as a “Home Link” device or it may be a hands-free transmitter that sends signals to the receiver 48 depending upon the proximity or position of the transmitter with respect to the controller. Upon confirmation of the transmitter's position, the controller may initiate movement of the barrier 16 depending upon the status of the barrier and the direction of travel with respect to the barrier of the vehicle-mounted transmitter 62.

Non-network devices may also include accessory devices which are enabled and controlled by the controller 14. Accordingly, upon receipt of a signal from any one of the previously mentioned non-network devices, the operator controller 14 may generate a signal that is emitted by a controller transmitter 66 and then received by accessories such as a doorlock 70, a light switch 72 or a light kit 74. For example, one of the smaller buttons on the remote transmitter 60 may be associated with control of the doorlock 70. Accordingly, actuation of the smaller button generates an operational signal received by the receiver 48. This signal is then processed by the controller 14 and, if authenticated, a corresponding signal is generated by the transmitter 66 for receipt by the lock 70. This signal enables the lock to move between locked and unlocked positions. In much the same manner a light, most likely in the area of the barrier 16, may be turned on and off. And, actuation of one of the other local transmitters may be used to turn on or off a light switch 72 that is located within the facility of the operator system. Accordingly, each of the local or non-network devices is able send non-network operational signals to the controller 14 by either a wired or wireless signal. Upon receipt of this non-network operational signal, the controller 14 determines whether the signal is appropriate and valid and then performs the associated function. As such, each operational signal includes an identification code or related code within a stream of data—that may or may not be encrypted—and which the controller routes and performs the function associated therewith. If the code cannot be identified—it has not yet been learned by the controller—then the controller takes no action and may return an invalid signal to the emitting device.

A network transceiver 90 is also connected to the controller 14 for the purpose of communicating network operational signals between the operator controller 14 and network transmitters and devices and, if desired, the network 20. The network operational signals may be wireless or wired in either a unidirectional or bidirectional format. In other words, the transceiver 90 may be connected to the controller 14 or other network devices in either a wired or wireless format. As previously discussed, the network world contains peripherals and other connections such as internet portals and/or personal computers to allow for communication with the operator controller 14. One or more of the devices contained within the network world may employ a network controller 92. As such, signals generated by the controller 14 and transmitted by the transceiver 90 may be received by a network transceiver 94. The operational signal can then be transferred to the network controller 92 which in turn directs the signal to the appropriate appliance, peripheral or computer, or other device associated with the network 20. If needed, the network controller 92 may access a network memory device 98 to confirm or validate any code within an operational signal. Accordingly, the network 20 may communicate with the operator controller 14 by first sending an appropriate operational signal to the controller 92 which utilizes the network transceiver 94 to communicate the signal to the operator transceiver 90. This information is then relayed to the operator controller 14 which in turn sends an appropriate signal to the designated device associated with the controller. Accordingly, any device in the network 20 may send an operational signal to a non-network or local device via the controller 14. For example, a user utilizing a device on the network, such as an internet portal, can send an instruction via a website to the network controller 92 so as to actuate the lock 70 in the non-network world.

A network device 99 can also be linked to the system 10. As shown, the network device 99 is a wireless remote transmitter that communicates with the operator controller via the network transceiver 90. It will be appreciated that all the different types of “local” devices that communicate with the controller 14, via either wired connections, or the transmitter 66 and the receiver 48, may instead be configured as network devices that reside in the network 20 and communicate via the transceiver 90 with the controller 14. Networked devices may behave in many cases like “local” devices however networked devices are not constrained by short communication linkages as in the case of local devices. Networked devices are capable of sending signals to each other directly and, as in the case of “mesh” type networks, may use each other as relay points to send signals from device to device. Networked devices are also able to stand on their own in a network without the need for a secondary device to “bridge” command signals between devices. In the case of the local light switch 72, controller 14 is needed to bridge the signal between it and local wall station 50. In other words, local wall station 50 is not capable of communicating with local light switch 72 if system 10 is removed. However, in the case of a network configuration a networked device 99 is capable of communicating directly with any devices on network 20 without the aid of a secondary device such as system 10.

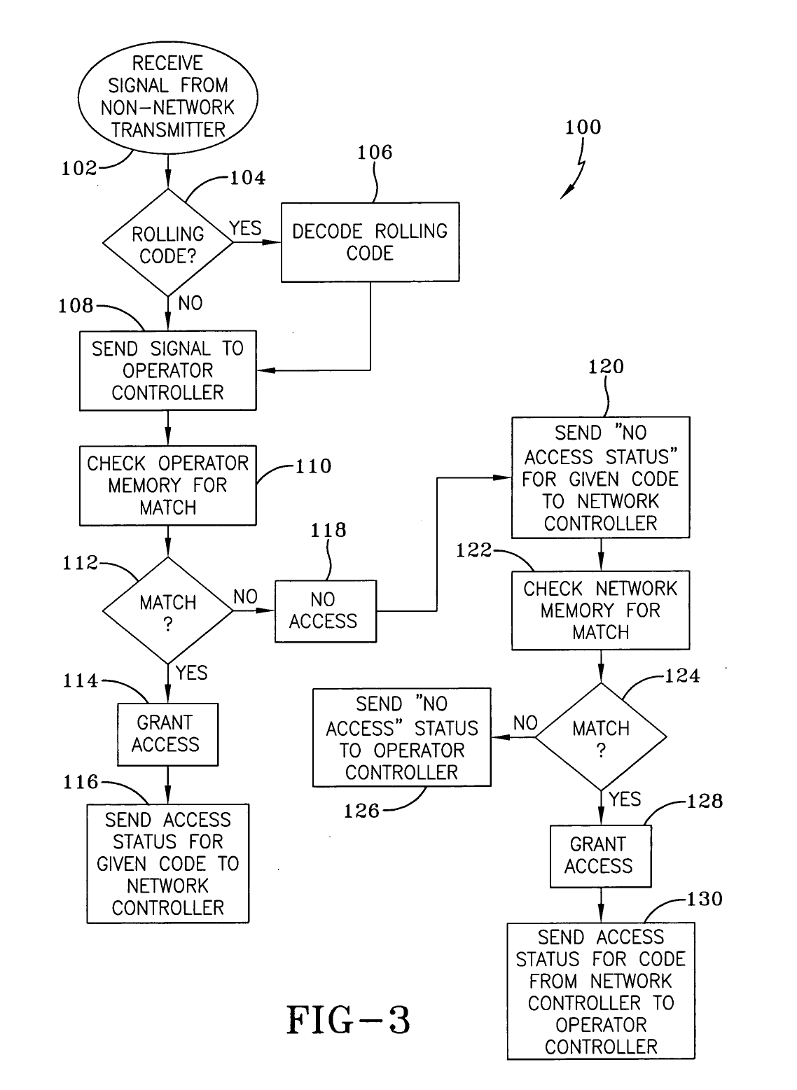

Referring now to FIG. 3, it can be seen that an operational flow chart is designated generally by the numeral 100 for the purpose of processing signals from a non-network or local transmitter. At a first step 102, an operational signal is received by the operator controller 14 from a non-network transmitter. Such a non-network transmitter may be transmitter devices 42, 50, 56, 60, 62 or other device such as a safety sensor 40. At step 104, the controller 14 inquires as to whether the operational signal received contains a rolling code or not. A rolling code changes upon each transmission and such a change in the transmission is anticipated by the controller so as to confirm the validity of the operational signal. In any event, if a rolling code is detected at step 104, the rolling code is decoded at step 106. If a rolling code is not detected, or the rolling code has been decoded, as at step 106, then at step 108 the signal is sent to the operator controller 14. Upon receipt of the signal, the operator controller 14 checks the internal memory 24 to determine whether the identifying code contained within the operational signal is matched or not. At step 112, the controller determines whether a match has been found and if so, then at step 114, access is granted and the requested operation is performed by the controller 14. Following this, at step 116, the access status for the given operational signal is sent to the network where a device such as the controller 92 can use the information for logging and other evaluation purposes.

Returning to step 112, if an operational signal does not contain a code that is matched at step 112, then at step 118 no access is permitted. Following this, at step 120, the operator controller 14 sends a “no-access” status for the given code to the network where a device such as controller 92 resides. The network controller 92, at step 122, then checks network memory 98 to determine if the code received is acceptable or not. Accordingly, if at step 124 no match is found, then at step 126, a “no access” status is returned to the operator controller 14 and no action is taken. In the alternative, some type of invalid or error signal may be returned to the original transmitting network device. However, if at step 124 a match is found in the queried memory device, then access is granted at step 128 and the requested function is performed. Next, at step 130, an access status signal is sent for the code from the operator controller 14 to the network where a device such as controller 92 can use the information for logging and other evaluation purposes. In this manner, a network transmitter or device is usable with the operator controller. As such, network devices or transmitters can be used to allow for any number of non-network or network functions to be implemented. If a network-type transmitter 99 is actuated in range of the operator controller 14, then that function is screened by the operator controller to determine whether it is an approved device and, if not, then the operator controller communicates with the network world to determine whether the device is approved for use with the controller. If so, then the action is implemented. If not, a return signal may be sent to the network transmitter. It will also be appreciated that control of the barrier or non-network component may be initiated directly from the network world by the network controller in an appropriate manner. And, operational and status information regarding operation of the linkage 30, the motor 26, and any observable phenomenon associated therewith can be collected by the network 20.

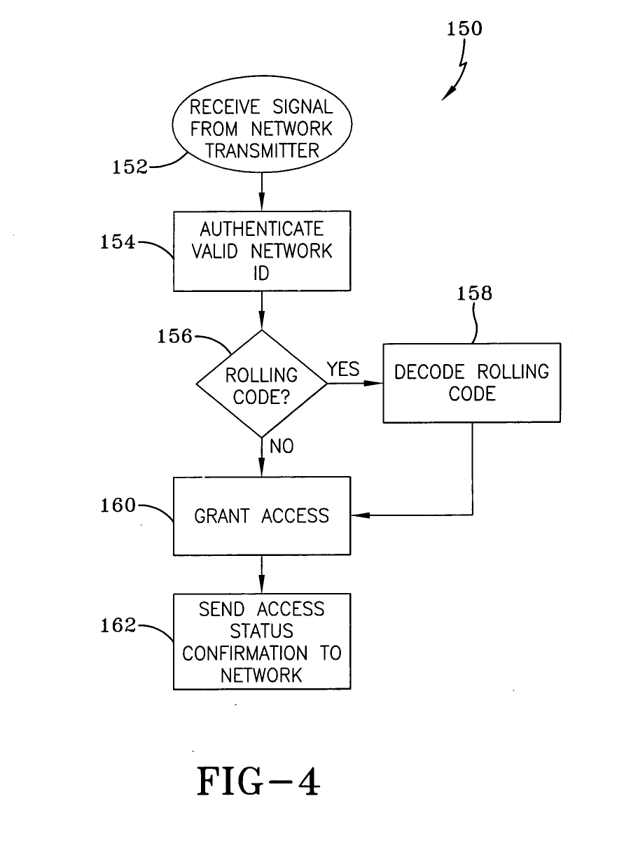

Referring now to FIG. 4, it can be seen that an operational flow chart is designated generally by the numeral 150 for the purpose of processing operational signals from a network transmitter or device. If a signal is received from a network device or transmitter in the network, then the operational signal is received by the network transceiver 90 at step 152. This transmission is authenticated as a valid network identification code at step 154 and then it is determined whether the signal is in a rolling code format or not. If a rolling code is used, then it is decoded at step 158. If a rolling code is not detected, or after the decoding of the rolling code at step 158, then at step 160 the device is granted access and the desired function is implemented. Following this, at step 162, an access status confirmation is sent to the network where a device such as controller 92 can use the information for logging and other evaluation purposes.

Based upon the foregoing, the advantages of the present invention are readily apparent. Primarily the network barrier operator system allows for a movable barrier operator to be controlled by a network. In other words, the operator controller can serve as a network portal such that the operational status of the barrier operator can be more easily monitored and controlled. The configuration allows for the operator to be controlled by a wired or wireless wall station interface and other well-known remote type transmitters to accept local control commands and also to receive, via a transceiver, commands from a network device. This also allows for the network device to control accessories directly programmed to the operator controller. Another advantage of the present invention is that it allows for implementation of a layered communication model and the supporting software and hardware in the barrier operator to be configured as a network node. This layered communication model ensures that the barrier operator and the network system can effectively communicate with one another. As such, data is passed from an external application to a physical connection on to the network and then back through the physical connection where the barrier operator's controller processes the data. This type of layered communication is commonly referred to as the open system interconnection seven-layer model. By implementing such a model, the barrier door operator is able to communicate with external systems and devices. And, this is done without regard to the propriety of the external system's programs or components being used to perform the communication. This layer comprises all and any type of physical means to move data from one place to another and, as such, covers both wired and wireless means of transmitting data.

Other advantages of the present invention are that the operator controller includes a wired or wireless transceiver which is used to communicate with the network world. In the case of a wired transceiver implementation, the operator only receives signals via a communications protocol sent through a wired bus. The wired bus includes at least one wire which allows the connection of the operator to the network world. Common types of wired networks such as Ethernet are bi-directional in nature, however, a unidirectional network can also be implemented. Accordingly, control devices connected to the network have the ability to control the operator functions as long as these devices are capable of sending operator command functions or operational signals. And, the operator controller can send commands, status and control functions to the rest of the network via the wired transceiver. In the event a wireless transceiver is implemented and connected to the controller, the operator controller can receive signals from the network world via compatible wireless devices. These wireless network devices can be in the form of handheld transmitters, wireless wall stations, vehicle-mounted transmitters, wireless key entries, computer systems, personal digital systems, personal computers and the like. In other words, all of the devices that are programmed directly to the controller can also be used to communicate to the controller via the network. As such, the operator has the capability of sending command, status and control functions to the rest of the devices connected to the network. In other words, local devices initially programmed to the operator controller can send commands through the operator controller and the network to control network devices such as appliances, locks and doors.

Yet another advantage of the present invention is that the operator may be equipped with a network wired or wireless network transceiver that can function as a local wired interface. This is advantageous for systems where users want to connect a standard operator wall station or push button to control simple functions such as door up/down and light on/off without disturbing the network connection. Accordingly, one clear advantage of the system relates to the inherent ability of the operator controller to act as a “bridge” device between non-network accessories and networked accessories. For example, there are millions of vehicle-mounted non-network capable transmitters in service. These devices are capable of interfacing with the operator via the “standard” short-range receiver. Once the signal is received, the operator controller is then capable of converting the transmission code from the vehicle into a format compatible with the network controller and then re-transmit the converted signal to the network for further processing by other network devices.

Still yet another advantage of the present invention is that the network operator system can be equipped with a network safety sensor interface. This interface is useful to connect operator specific safety sensors to the operator and thus the network. The safety sensors can be of the infrared type, ultrasonic type and switch astragal type. Status from these sensors can be decoded by the operator controller and converted to a format compatible with the network controller and connected devices. Accordingly, the operator is capable of sending operational status signals from the safety sensors for further processing by the network devices. With this enhanced communication capability, the operator controller, regardless of the type of hardware included in its systems, is capable of sending requests, status and commands to the network and also receive requests, status and commands from the network. As such, the network controller and the operator controller can share memory systems if desired and ideally the memory systems are stored on the network to allow for expanded storage capability.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A movable barrier operator for moving a barrier between limit positions, comprising:
a motor attachable to the barrier;
at least one non-network device;
at least one network device; and
a controller connected to said motor, said controller communicating operational signals between said at least one non-network device and said at least one network device to said motor, and communicating operational signals between said motor and said at least one non-network device and said at least one network device.

2. The moveable barrier operator according to claim 1, further comprising:
a network transceiver connected to said controller, said network transceiver communicating operational signals between said controller and said at least one network device.

3. The movable barrier operator according to claim 2, wherein said network transceiver communicates with said at least one network device via wireless signals.

4. The movable barrier operator according to claim 2, wherein said controller determines whether said at least one network device has generated an acceptable operational signal.

5. The movable barrier operator according to claim 4, further comprising:
a memory device connected to said controller, said memory device having acceptable codes stored therein and said controller comparing an identifying code received in said operational signals to said acceptable codes to determine whether said operational signal is acceptable or not, if said operational signal is not acceptable said controller communicates with said at least one network device to determine whether said command code is acceptable or not, and
if said operational signal is acceptable said controller performs an appropriate function.

6. The movable barrier operator according to claim 4, wherein said at least one non-network device is selected from a group consisting of a remote transmitter, a keyless entry transmitter, a wall station transmitter, a safety sensor, a light kit, a light switch, a door lock, and a vehicle mounted transmitter.

7. The movable barrier operator according to claim 4, wherein said at least one network device is selected from a group consisting of peripherals, appliances, computers, a remote transmitter, a keyless entry transmitter, a wall station transmitter, a safety sensor, a light kit, a light switch, a door lock, and a vehicle mounted transmitter.

8. The movable barrier operator according to claim 2, wherein said network transceiver communicates operational signals between said at least one non-network device and said at least one network device.

9. The movable barrier operator according to claim 8, wherein said controller generates and receives a multicast operational signal via said network transceiver.

10. A system for moving a barrier between limit positions comprising:
a motor linked to the barrier;
a non-network receiver;
a network transceiver, and
an operator controller programmed to:
maintain an operator memory device which stores approved codes therein;
receive operational signals from non-network devices via non-network receiver and from network devices via said network transceiver, said operational signals having a command code contained therein; and
compare said command codes to said approved codes, and if a match is found, generate another said operational signal to one of said motor, said non-network devices, and said network devices.

11. The system according to claim 10, further comprising:
a network controller associated with said network devices, said network controller programmed to:
maintain a network memory device which stores approved codes therein;
communicate operational signals between said network devices and said operator controller; and
receive non-approved command codes from said operator controller if a match is not found; and
compare said non-approved command codes to said approved codes stored in said network memory, and if a match is found, send another of said operational signals to said operational controller.

12. The system according to claim 11, wherein at least some of said operational signals between said network controller and said network transceiver are wireless.

13. The system according to claim 12, wherein said non-network device is selected from a group consisting of a remote transmitter, a keyless entry transmitter, a wall station transmitter, a safety sensor, a light kit, a light switch, a door lock, and a vehicle mounted transmitter.

14. The system according to claim 12, wherein said network device is selected from a group consisting of peripherals, appliances, computers, a remote transmitter, a keyless entry transmitter, a wall station transmitter, a safety sensor, a light kit, a light switch, a door lock, and a vehicle mounted transmitter.

15. The system according to claim 12, wherein said network controller and said operator controller are programmed to exchange multi-cast operational signals.

16. The system according to claim 12 wherein said operator controller is programmed to:
generate and send operational signals to said network controller related to an operational status of said motor.

17. The system according to claim 12 wherein said network controller is programmed to:
generate and send operational signals to at least said operator controller.

18. The system according to claim 10, wherein said operator controller is further programmed to:
maintain a network memory device which stores approved network codes therein;
receive said operational signals from network devices via said network transceivers; and
compare said command codes to said approved network codes, and if a match is found, general another said operational signal to one of said motors, said non-network devices and said network devices.
